(19) United States
(12) Patent Application Publication
(10) Pub. No.: US 2015/0295524 A1
(43) Pub. Date: Oct. 15, 2015

(54) SAFE TORQUE OFF PROCEDURE

(71) Applicant: ABB Technology Oy, Helsinki (FI)

(72) Inventors: Ilpo KANGAS, Helsinki (FI); Antti-Ilmari KEKKI, Helsinki (FI); Olli KESKI-RAHKONEN, Helsinki (FI); Tero VIITANEN, Helsinki (FI)

(73) Assignee: ABB Technology Oy, Helsinki (FI)

(21) Appl. No.: 14/682,623

(22) Filed: Apr. 9, 2015

(30) Foreign Application Priority Data
Apr. 10, 2014 (EP) 14164178.7

(51) Int. Cl. H02P 3/06

(52) U.S. Cl. CPC H02P 3/06

(57) ABSTRACT

A method and an arrangement of producing a safe torque off procedure of an electrical drive including a control unit and one or more power units having controllable semiconductor switches. The method includes detecting a signal in a control unit indicating a requirement to stop the drive, generating, based on the detected signal, at least one safety-approved signal which when received in a power unit initiates shutting-down of the power unit, feeding the generated at least one safety-approved signal to one or more power units, and initiating the shutting down of the one or more power units upon the receipt of the at least one safety-approved signal, the at least one safety-approved signal initiating at least two different shut-down procedures of the one or more power units at different time instants.

### RELATED APPLICATION(S)

This application claims priority under 35 U.S.C. §119 to European Patent Application No. 14164178.7 filed in Europe on Apr. 10, 2014, the entire content of which is hereby incorporated by reference in its entirety.

### FIELD

The present disclosure relates to electrical motor drives, for example, to procedures in electrical motor drives in connection with machine safety.

### BACKGROUND INFORMATION

Certain safety regulations and standards govern electrical motor drives in various applications. An example of such a standard is IEC 61800-5-2 which defines Safe Torque Off-function (STO). STO brings the motor of the electrical drive to a no-torque state each time the function activates. STO can be used as an actuating procedure both in stopping of the motor (for example, over heat protection, over speed protection or emergency stop of the motor) or in preventing undesired starting of the motor.

STO function can be implemented as a single channel or redundant architecture of two or more channels. The redundancy should be implemented in such a way that a single fault in the system does not disable the STO procedure from removing the torque from the motor. The redundancy helps in obtaining a higher level safety approval for the STO.

FIG. 1 shows an example of a system capable of implementing STO procedure. In this example a motor is separated from the supplying network by cutting off the power from the drive using an electromechanical switch 2. The problems relating to the example of FIG. 1 are the high costs involved and the implementation of redundancy only by using two separate electro-mechanic components. Further, even when redundancy is implemented, it can be difficult to obtain desired protection against common-cause faults. Further, the procedure of FIG. 1 does not take into account the energy stored inside the device, and therefore a torque can still be produced using this stored energy.

A more advanced STO procedure is shown in FIG. 2 in which a control unit of a motor drive receives STO signals STO1, STO2 and sends them to a power module, such as an inverter. The inverter receives the signals and based on the state of the signal can block the use of the power semiconductor components. This can be done, for example, by removing the gate pulses or by removing voltage supply from the gate drivers of the semiconductor components.

In the example of FIG. 2, the STO1 and STO2 signals inputted to the control unit are inputted from the same source. The redundancy is obtained in the inverter when the signals initiate different protective action.

Further, in the example of FIG. 2, the signals are fed via dedicated signal lines 21. These signal lines should comply both with electrical safety regulations and with machines functional safety standards. The signal lines also include electrical separation which is used for separating the low voltage of the control unit 23 from the higher voltages of the power unit 24. In view of machine safety, the approved connections are shown with thicker lines. The other parts of the circuit of FIG. 2 relate to providing status information of the STO-procedure, i.e. indicating that the required operations are carried out. This communication is led through the commonly used signaling shown in FIG. 2 as the double ended arrow between the FPGA blocks. In the example of FIG. 2, the torque-free state is obtained by removing supply voltages from the gate drivers. This is carried out with blocks 25 and 26 such that block 25 removes voltages of the upper semiconductor switches and block 26 removes voltages from the lower semiconductor switches. The states of the signals STO1 and STO2 are fed also to the FPGA circuit 27 of the control unit and to the FPGA circuit 28 of the power unit. The state information from the STO signals is transmitted between the units for diagnosing the operation of the STO-functionality.

Both of the systems of FIGS. 1 and 2 use STO-functionality that can have unexpected consequences in the circuitry of the inverter. The STO procedure operates as desired but the abrupt removal of modulation pulses can lead to failure of power components in the inverter.

### SUMMARY

A method is disclosed of producing a safe torque off procedure of an electrical drive including a control unit and one or more power units having controllable semiconductor switches, the method comprising: detecting a signal in the control unit indicating a requirement to stop the drive; generating, based on the detected signal, at least one safety-approved signal which when received in a power unit initiates shutting-down of the power unit; feeding the generated at least one safety-approved signal to one or more power units; and initiating the shutting down of the one or more power units upon receipt of the at least one safety-approved signal, the at least one safety-approved signal initiating at least two different shut-down procedures of the one or more power units at different time instants.

An arrangement for producing a safe torque off procedure of an electrical drive including a control unit and one or more power units having controllable semiconductor switches, wherein the arrangement comprises: means for detecting a signal in a control unit indicating a requirement to stop an electrical drive; means for generating, based on the detected signal, at least one safety-approved signal which when received in a power unit will initiate shutting-down of the power unit; means for feeding the at least one safety-approved signal to one or more power units; and means for initiating the shutting down of the one or more power units upon receipt of the at least one safety-approved signal, wherein the at least one safety-approved signal will initiate at least two different shut-down procedures of the one or more power units at different time instants.

### BRIEF DESCRIPTION OF THE DRAWINGS

In the following the disclosure will be described in greater detail by exemplary embodiments with reference to the accompanying drawings, in which:

FIGS. 1 and 2 show known STO implementations;

FIGS. 3, 4, 5 and 7 show different exemplary embodiments of the disclosure; and

FIG. 6 shows an exemplary embodiment of the disclosure with parallel power units.

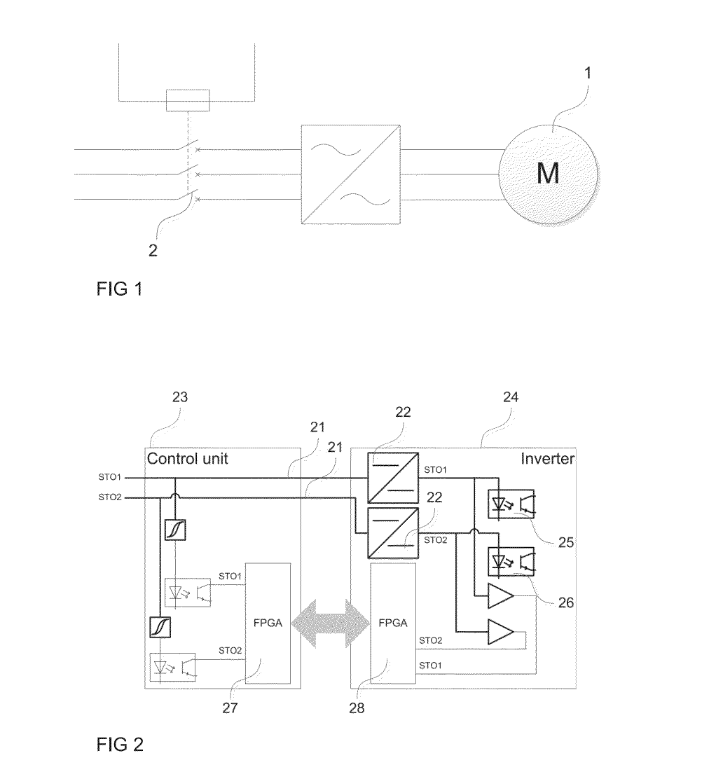

### DETAILED DESCRIPTION

Exemplary embodiments of the disclosure are based on producing one or more safety-approved signals in the control unit of a motor drive. The one or more safety-approved signals are fed to the power unit, and upon receipt of the signals, the power unit initiates shut-down of the power unit in such a manner, that two different shut-down procedures are used. Further, these procedures are used at different time instants.

According to exemplary embodiments of the disclosure, the shut-down procedure applied first is a normal stop-procedure in which the power unit is shut down in a controlled manner. The second shut down procedure is then a procedure leading to removing torque from the motor and ensuring that torque is not produced. Thus the procedure fulfils the requirements for a STO function.

In an exemplary embodiment of the disclosure, a signal commanding a normal stop procedure is produced in the control unit and fed as non-safety-approved signal to the power unit(s), while in another exemplary embodiment of the disclosure, a stop-signal is produced in the power unit(s) from the safety-approved signal(s) fed from the control unit.

An advantage of the exemplary embodiment of the disclosure is that the STO-procedure does not lead to a situation in which the power module is shut-down abruptly. This can ensure that the components of the power module are not damaged due to sudden removal of control. Further, as the one or more signals from the control unit are safety-approved, the same STO-functionality can be applied to different drive topologies without the need of re-design and approval procedures.

According to a method of an exemplary embodiment of the disclosure, a safe torque off (STO) procedure can be produced. The procedure is implemented in an electrical drive including a control unit and one or more power units. The disclosure can also be implemented in a drive with combined control and power units. In normal use of the electrical drive the control unit sends control information to the one or more power units. The control information can include reference values for current to be outputted from the power unit or torque to be produced by the electrical motor of the drive, for example. The control unit can further process different calculations relating to the control, such as different calculations relating to control of the motor.

The power unit includes controllable semiconductor switches which can be controlled according the control information sent by the control unit. The power unit can be, for example, an inverter which powers a motor connected to the output of the power unit in a desired manner. The electrical drive can also include multiple power units which can all be controlled by a control unit. The outputs of the multiple power units can be connected in parallel for driving a common load. The multiple of power units can also be separate systems each having their own load. As the STO procedure relates to setting a motor to a no-torque state, the power unit with semiconductor switches can be a device that is able to control a motor.

The control unit and the power unit can be connected to each other with any suitable communications connection that enable communication between the units. Such communications connections include, but are not limited to, galvanic connections, fibre links, communications buses and wireless communication.

According to an exemplary embodiment of the method according to the disclosure, a signal initiating the drive to become in a no-torque state is detected in the control unit. Multiple of signal paths from safety related sensors or the like can be led to the control unit depending on the application. Each of these paths or signals is monitored and once any one of the signals activates the motor should be made torqueless.

The detected signal originates for example from a safety related logic device that monitors a sensor. Such a sensor can be a presence sensor indicating that a person is present in a dangerous area or a sensor indicating that a safety related mechanical door or hatch is opened, for example. An example of other possible source of the signal is from emergency stop button. Any of the signals initiate that the motor in of the system should be brought to a state in which the motor is not able to produce torque.

Further, according to an exemplary embodiment of the method according to the disclosure, on the basis of the detected signal at least one safety-approved signal is generated in the control unit. This signal initiates the shutting-down of the power unit once received in the power unit.

The safety approved signal referred above is a signal that fulfils the requirements set for the STO-procedure. Such a signal can be led via any connection that has been safety-approved or fulfils the requirements for such approval. The signal can be a signal in any communications link, for example, galvanic, fibre optic, wireless, etc., that is established between safety-approved devices.

According to an exemplary embodiment, the safety approved signal is a signal between safety-approved elements. Such elements can be, for example, partly safety-approved field-programmable gate arrays (FPGA). Thus the control unit and the power units include a safely-approved device where a safety-approved link can be established between the control unit and the power units.

Safety-approved FPGAs can be programmed using safety approved tools and measures, including safety-approved software for implementing safety-related functions and operations. A safety device utilizing such FPGAs can obtain safety-approval and the safe block in the FPGA can be frozen once approved such that the non-safe block of the FPGA can be programmed without requiring getting a re-approval for the safe side.

When the standard communication between the control unit and the power unit(s) is between the communication interfaces of FPGAs, for example, the STO-command does not require any other communication connection. The STO-command can be, for example, encrypted in the safe-side of the FPGA and sent via standard communications channel in a so called “black channel.” Black channel refers to communication in which regardless of the communications protocol used in standard communication, the critical communication is coded in a specific way and a set communication protocol is used. The communication in black channel is also safety-approved in the sense of the STO-functionality. When using black channel with encrypted signalling, the receiving power module decrypts the signal in the safety approved block of the unit, such as in FPGA.

The generated at least one safety-approved signal is fed to the one or more power units. As the power unit receives the at least one safety-approved signal, the shutting down of the power unit is started. According to exemplary embodiments of the method according to the disclosure, the signal initiates at least two different shut-down procedures of the power unit that received the signal. Further, the at least two procedures for shutting-down the power unit can be performed at different time instants.

The first of the shut-down procedures that is applied at each of the power units can be a controlled shut-down procedure. The controlled shut-down procedure turns the power semiconductors of the power unit to an OFF-state and stops the modulation according to a set procedure. In a two-level inverter the procedure can be quite simple to implement by cutting the gate pulses to the power semiconductors at different time instants. In parallel-connected two-level inverters feeding a common load or in multilevel inverters the procedure can be more complicated and individual power components can be required to be shut-down in certain order. As power units can contain a Stop-procedure that is followed in normal stopping of the device, this Stop procedure is used as a first procedure for shutting down the power unit when the safety-approved signal indicating transition to no-torque state is received.

The second of the shut-down procedures initiated by the signal indicating the no-torque state is a procedure with which the power unit is made incapable of producing torque in the sense of STO-requirements. Once this second procedure is started, the power unit is already stopped with the normal stop procedure.

The second procedure, for example, cuts the supply voltages of the gate drivers of the power semiconductors of the power unit or cuts the modulation pulses from the power semiconductors. This second procedure is any known procedure that fulfils the STO-requirement.

The order of the shut-down procedures implemented as the normal Stop-procedure can be carried out in less than 50 microseconds and several milliseconds can be used to implement the torque-free state. As the time required for the normal stop-procedure can be known, it is desirable to set a time delay for the second procedure such that the second procedure is started only after the first procedure has ended. However, the delay should not be so long that the no-torque state is achieved later than required.

As the normal shut-down procedure has ended prior to disabling the power unit, the power components of the power unit, such as inverter, are not damaged due to STO-command. This can further improve the safety aspect as there is no danger of sudden break or even explosion of components due to high currents and voltages that are not controlled.

According to an exemplary embodiment of the disclosure, the two shut-down procedures that can be implemented in the power unit are both such procedures that lead to a safety-approved no-torque state. In such an embodiment the torque-free state is obtained by any two known procedures that lead to STO-state. These procedures can be, for example removing the gate pulses or auxiliary voltages. As mentioned above, in two-level inverters the risk of component failure is small, and therefore the Stop-signal is not necessarily required.

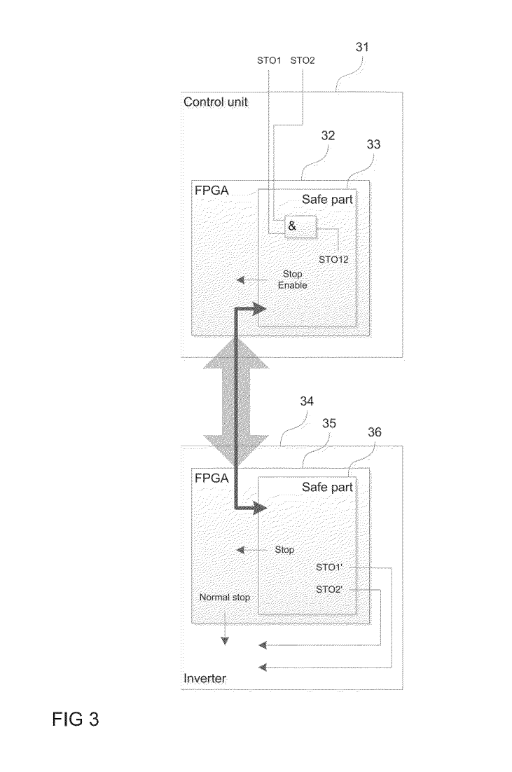

In the following the disclosure is described in connection with embodiments of the FIGS. 3, 4, 5 and 7.

In the embodiment of FIG. 3, control unit 31 monitors signal lines STO1 and STO2. These signals can be originated, for example, from an emergency stop button or from a safety-approved relay. In general, STO1 and STO2 signals or signal lines can be from a source that monitors safety related functions such that when a signal is absent from the line, the motor or motors of the system should be made torque-free.

The signal lines STO1, STO2 can be fed to a FPGA circuit 32, and more specifically to a safety approved block 33 of the FPGA circuit. In the FPGA circuit the signals can be fed to a logic AND function such that the signals from signal lines STO1, STO2 can be combined to a single signal STO12 as the output of the AND circuit. Signal STO12 changes its state as soon as one or both of the signals STO1 or STO2 change their states.

In FIG. 3, when the STO12 signal changes its state to indicate that either or both of signals STO1 or STO2 have changed its state, a stop signal can be generated. Alternatively, an enable signal is de-set to disable the power unit. The stop signal or enable signal can be sent to the power unit together with the STO12 signal. The STO12 signal is sent from the safety block of the control unit to the safety block of the power unit together with the normal communication between the units in a black channel.

Once the STO12 and stop (or disable) signals can be received in power unit 34, the power unit is shut down. The shut-down is performed by sending a Stop signal from the safety block 35 of the FPGA 36 and implementing a controlled stop of the device. Further, the safety block 35 produces signals STO1′ and STO2′ from the STO12 signal. These produced signals can be used for producing the torque free state as required by the STO procedure. In an exemplary embodiment of the disclosure, the generation of the STO1′ and STO2′ signals can be delayed such that before implementing the required operations, the power unit, such as inverter, is already stopped in controlled manner.

As with the Stop signal, the change of Enable signal to disable state performs a controlled stop of the power unit. The enable signal is used in a motor drive for allowing the operation of the drive. Thus the enable signal allows the drive to be started and to continue the operation of the drive, for example, producing torque to the motor.

It should be noted, that Stop or Enable can be used to bring the power unit to a no-torque state. However, such a no-torque state is not safety-approved in the sense of machine safety.

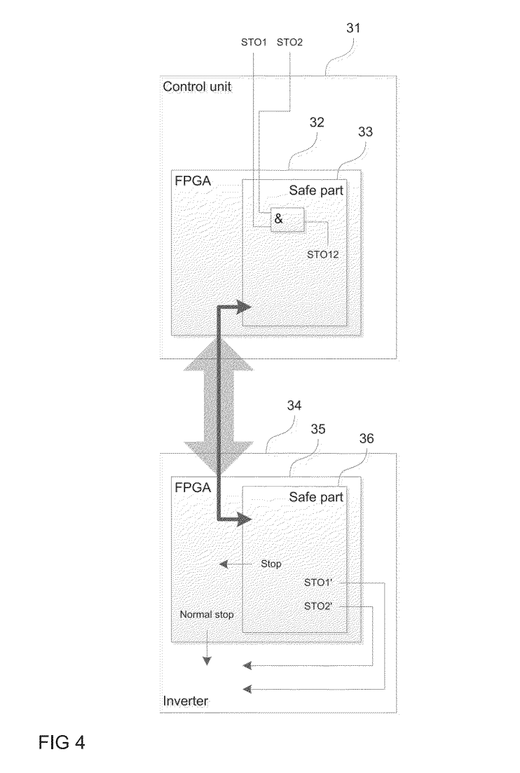

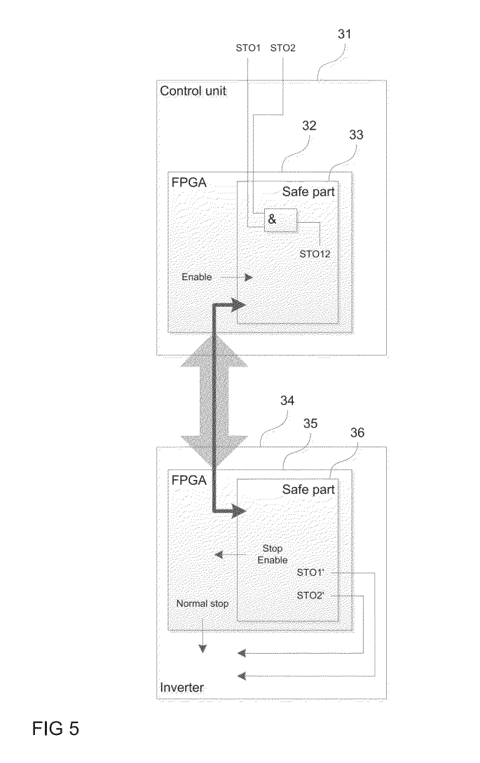

The exemplary embodiment of FIG. 4 differs from the embodiment of FIG. 3 in that in FIG. 4 only the STO12 signal is encrypted in the black channel between the control unit and the power unit and the stop command is produced in safe part 36 of the power unit instead of safe part 33 of the control unit of FIG. 3. Once the safety part of the FGPA of the power unit receives the STO12 signal for indicating the need for providing a no-torque state, the safety part forms a Stop signal for stopping the power unit in a controlled manner. After the operation has been stopped, the STO-requirement is fulfilled with desired action.

The embodiment of FIG. 5 differs from the embodiment of FIG. 3 in that the Enable signal is fed from the non-safe side of FPGA of control unit to the safety approved side. Thus the enable signal used in normal operation to allow the operation of the drive, is used to stop the drive in case signals STO1 or STO2 change their state. Alternatively, the drive enable signal is integrated to the STO12 signal, thus ensuring that the torque producing operation can be prevented whenever STO1 or STO2 change their state. Further, in the embodiment the signals STO12 and Enable can be sent in the black channel between the units as in connection with the embodiment of FIG. 3.

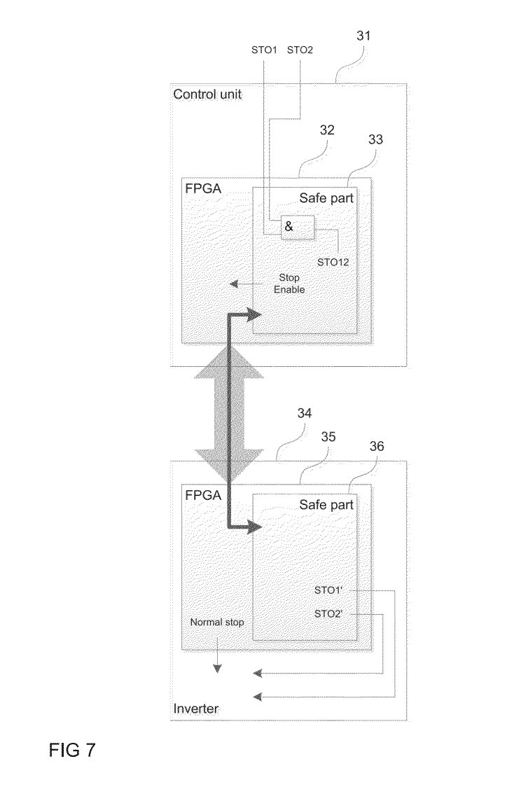

FIG. 7 shows an exemplary embodiment of the disclosure in which Stop or Enable signal is generated in the safe part of the control unit 31 and communicated to the power unit using a non-safety approved communication route. In the embodiment the STO12 signal is communicated to the power unit using the black channel as in the previous embodiments.

In the above examples two STO signals can be fed to the FPGA of the control unit. The two signals can be given as examples and the number of STO-signals is not limited and the number is dependent on the use of the device.

Further, as a part of the requirement of the STO-functionality, the one or more power units communicate diagnostic data on state of the torque free operation state back to the control unit in similar manner as the control unit communicates to the power units. A pre-determined check message is also sent between the units as a part of the secure communication. If this message is not received by the units, then the operation of the power units can be stopped and STO-functionality is applied automatically.

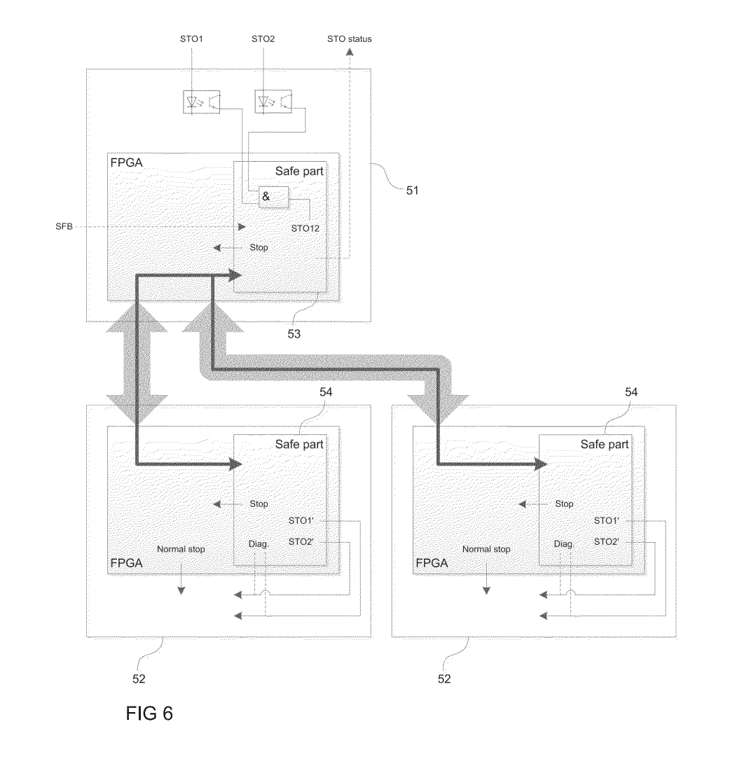

FIG. 6 shows an exemplary embodiment of the disclosure in which one control unit 51 controls two parallel power units 52. The power units, such as inverters, can be controlling separate loads or a common load with same control information. Safe torque off signals STO1 and STO2 can be inputted to the control unit, and more specifically to the safety block 53 of a FPGA circuit. The STO signals can be encrypted as a single STO12 signal as in previous examples. Further, in the example of FIG. 6, a Stop signal is generated in the safety block of the FPGA. The Stop signal and the STO12 signals can be communicated in the black channel together with the normal control information to the parallel power units 52.

STO12 and Stop signals can be fed to the safety blocks 54 of the power units. Upon receipt of the signals the power units can be switched off first by normal controlled stop procedure and after that with a procedure that leads to a torque free state.

FIG. 6 shows how the safety block of the power units monitors the STO1′ and STO2′ signals generated by the secure block with Diag.-inputs. The monitored information is communicated in the black channel to the control unit, and the control unit outputs a STO status-signal indicating the operation of the STO functionality. Further in FIG. 6 a safety field bus SFB is shown to be connected to the secure block of the FPGA of the control unit. The safety field bus can also contain STO information or activation signal used in generation of STO functionality.

The arrangement of the disclosure implements the method of the disclosure in such a manner that a simple structure is obtained. The method can be implemented in various types of drive systems requiring the use safe torque off-functionality. The implementation of the method in an arrangement leads to a structure in which the type of the power unit can be any known power unit suitable to be used in a drive system. The safety approved signal is led in a safety approved signal path to a safety approved part of the power unit. In the power unit the signal initiates a pre-determined and controlled stop operation and furthermore produces a second means for ensuring a no-torque state in the sense of the safety related regulations.

In the above, specific examples can be described in connection with the drawings. The disclosure is not limited to the examples and the different specific structures presented therein. For example, FPGA circuits can be presented as implementing the safety blocks. However, other suitable circuits or circuit structures can also be used.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A method of producing a safe torque off procedure of an electrical drive including a control unit and one or more power units having controllable semiconductor switches, the method comprising:
detecting a signal in the control unit indicating a requirement to stop the drive;
generating, based on the detected signal, at least one safety-approved signal which when received in a power unit initiates shutting-down of the power unit;
feeding the generated at least one safety-approved signal to one or more power units; and
initiating the shutting down of the one or more power units upon receipt of the at least one safety-approved signal, the at least one safety-approved signal initiating at least two different shut-down procedures of the one or more power units at different time instants.

2. The method according to claim 1, comprising:
generating by the control unit, two safety-approved signals, one of them being a signal leading the one or more power units to a torque-free state and the other being a signal stopping the one or more power units in a controlled manner.

3. The method according to claim 1, comprising:
generating, by the control unit, a safety-approved signal leading the one or more power units to a torque free state, and wherein the one or more power units generate a signal stopping the one or more power units in a controlled manner based on a received safety-approved signal.

4. The method according to claim 1, comprising:
transmitting the signals via signal paths carrying control information between the control unit and the one or more power units.

5. The method according to claim 1, wherein the one or more power units, upon receipt of the one or more safety approved signals stop an operation.

6. The method according to claim 5, comprising:
stopping the operation of the one or more power units first in a controlled manner and after that in a manner producing a torque-free state.

7. The method according to claim 6, comprising:
delaying the torque-free state producing stop so that the one or more power units are already in a stopped state before applying the torque-free state producing stop.

8. The method according to claim 1, comprising:
communicating the one or more safety-related signals between the control unit and the one or more power units with a protocol differing from the other communication between the one or more power units.

9. The method according to claim 1, wherein the one or more power units receive control information from a control unit for driving a common load and the control information from the control unit is the same to all the power units.

10. The method according to claim 1, wherein the power units receiving control from the control unit receive different control information.

11. The method according to claim 1, wherein the power units control one or a plurality of motors.

12. An arrangement for producing a safe torque off procedure of an electrical drive including a control unit and one or more power units having controllable semiconductor switches, wherein the arrangement comprises:
means for detecting a signal in a control unit indicating a requirement to stop an electrical drive;
means for generating, based on the detected signal, at least one safety-approved signal which when received in a power unit will initiate shutting-down of the power unit;
means for feeding the at least one safety-approved signal to one or more power units; and
means for initiating the shutting down of the one or more power units upon receipt of the at least one safety-approved signal, wherein the at least one safety-approved signal will initiate at least two different shut-down procedures of the one or more power units at different time instants.

13. An arrangement according to claim 12, in combination with an electrical drive including a control unit and one or more power units having controllable semiconductor switches,
wherein the control unit is configured to generate two safety-approved signals, one of them being a signal leading the one or more power units to a torque-free state and the other being a signal stopping the one or more power units in a controlled manner.

14. An arrangement according to claim 12, in combination with an electrical drive including a control unit and one or more power units having controllable semiconductor switches,
wherein the control unit is configured to generate, a safety-approved signal leading the one or more power units to a torque free state, and wherein the one or more power units are configured to generate a signal stopping the one or more power units in a controlled manner based on a received safety-approved signal.

15. An arrangement according to claim 12, comprising:
signal paths for carrying transmitted signals carrying control information between a control unit and the one or more power units.

16. An arrangement according to claim 12, in combination with an electrical drive including a control unit and one or more power units having controllable semiconductor switches,
wherein the one or more power units, upon receipt of the one or more safety approved signals, are configured to stop an operation.

17. An arrangement according to claim 16,
wherein the one or more power units are configured to stop the operation first in a controlled manner and after that in a manner producing a torque-free state.

18. An arrangement according to claim 17,
wherein the one or more power units are configured to delay the torque-free state producing stop so that the one or more power units are already in a stopped state before applying the torque-free state producing stop.

19. An arrangement according to claim 12, in combination with an electrical drive including a control unit and one or more power units having controllable semiconductor switches,
wherein the control unit is configured to communicate the one or more safety-related signals between the one or more power units with a protocol differing from the other communication between the one or more power units.

20. An arrangement according to claim 12, in combination with an electrical drive including a control unit and one or more power units having controllable semiconductor switches,
wherein the one or more power units are configured to receive control information from the control unit for driving a common load and the control information received from the control unit is the same to all the power units.
